(19) United States
(12) Patent Application Publication
(10) Pub. No.: US 2016/0380425 A1
(43) Pub. Date: Dec. 29, 2016

(54) SNUBBER CIRCUIT, POWER CONVERTER AND METHODS OF OPERATING THE SAME

(71) Applicant: SUNPOWER CORPORATION, San Jose, CA (US)

(72) Inventors: Patrick Chapman, Austin, TX (US); Alex Gray, Austin, TX (US)

(73) Assignee: SUNPOWER CORPORATION, San Jose, CA (US)

(21) Appl. No.: 14/751,541

(22) Filed: Jun. 26, 2015

(51) Int. Cl. H02H 3/20; H02M 3/335

(52) U.S. Cl. CPC H02H 3/20; H02M 3/33507

(57) ABSTRACT

A snubber circuit for use with a power converter having an input inductor coupled to a winding of a transformer, and method of operating the same. In one embodiment, the snubber circuit includes a series-coupled clamp diode and a clamp capacitor coupled across the input inductor. The snubber circuit further includes a clamp switch coupled across and configured to regulate a voltage of the clamp capacitor.

### BACKGROUND

Photovoltaic (“PV”) panels are generally fabricated with strings of PV cells connected in series to convert solar insolation to electric power. The PV panels have traditionally been manufactured as independent components that employ external power conversion apparatus (e.g., power supplies) to optimize an operating point of the PV panel (e.g., maximum power point tracking), and convert direct current (“dc”) power generated by the PV panel to an alternating current (“ac”) power for connection to a local utility grid. The PV panels are now being fabricated as modules with integrated power supplies that provide the ac power at an output thereof.

The overall electrical performance of a PV panel such as efficiency that converts solar insolation to electrical output power is a performance metric that depends on multiple factors. It is often desirable for safety and other reasons to construct the integrated power supply with an isolation barrier that metallically and safely separates electrical conductors on the power input of the isolation barrier from the power output of the isolation barrier. Such isolation barriers in a power supply are generally constructed with a transformer with windings on a primary side being isolated from windings on a secondary side. The transformers generally introduce circuit parasitic elements such as transformer leakage inductance that can adversely affect power conversion efficiency of the power supply if not carefully addressed during the design of the PV panel. Thus, a circuit that mitigates losses associated with the circuit parasitic elements would be advantageous for the design of the PV panel.

### BRIEF DESCRIPTION OF THE DRAWINGS

For a more complete understanding of the present disclosure, reference is now made to the following descriptions taken in conjunction with the accompanying drawings, in which:

FIG. 1 illustrates a block diagram of an embodiment of a power supply employable with a photovoltaic panel;

FIG. 2 illustrates a schematic diagram of an embodiment of a portion of a power supply employable with a photovoltaic panel;

FIG. 3 illustrates a schematic diagram of another embodiment of a portion of a power supply employable with a photovoltaic panel; and

FIG. 4 illustrates a flow diagram of an embodiment of a method of operating a photovoltaic module.

Corresponding numerals and symbols in the different figures generally refer to corresponding parts unless otherwise indicated. The figures are drawn to clearly illustrate the relevant aspects of the preferred embodiments and are not necessarily drawn to scale

### DETAILED DESCRIPTION OF ILLUSTRATIVE EMBODIMENTS

The following detailed description is merely illustrative in nature and is not intended to limit the embodiments of the subject matter of the application or uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Terminology. The following paragraphs provide definitions and/or context for terms found in this disclosure (including the appended claims):

“Comprising.” This term is open-ended. As used in the appended claims, this term does not foreclose additional structure or steps.

“Configured To.” Various units or components may be described or claimed as “configured to” perform a task or tasks. In such contexts, “configured to” is used to connote structure by indicating that the units/components include structure that performs those task or tasks during operation. As such, the unit/component can be said to be configured to perform the task even when the specified unit/component is not currently operational (e.g., is not on/active). Reciting that a unit/circuit/component is “configured to” perform one or more tasks is expressly intended not to invoke 35 U.S.C. §112, sixth paragraph, for that unit/component.

“First,” “Second,” etc. As used herein, these terms are used as labels for nouns that they precede, and do not imply any type of ordering (e.g., spatial, temporal, logical, etc.). For example, reference to a “first” state of operation of a PV module does not necessarily imply that this state is the first state in a sequence; instead the term “first” is used to differentiate this state from another state (e.g., a “second” state).

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

“Coupled.” The following description refers to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically.

“Inhibit.” As used herein, inhibit is used to describe a reducing or minimizing effect. When a component or feature is described as inhibiting an action, motion, or condition it may completely prevent the result or outcome or future state completely. Additionally, “inhibit” can also refer to a reduction or lessening of the outcome, performance, and/or effect which might otherwise occur. Accordingly, when a component, element, or feature is referred to as inhibiting a result or state, it need not completely prevent or eliminate the result or state.

In addition, certain terminology may also be used in the following description for the purpose of reference only, and thus are not intended to be limiting. For example, terms such as “upper”, “lower”, “above”, and “below” refer to directions in the drawings to which reference is made. Terms such as “front”, “back”, “rear”, “side”, “outboard”, and “inboard” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import.

Embodiments will be described in a specific context, namely, a snubber circuit for use with a power converter of a power supply, and methods of operating the same. While the principles of the present disclosure will be described in the environment of a power converter, any application such as a power amplifier or motor controller formed with a power converter that may benefit from such a snubber circuit is well within the scope of the present disclosure.

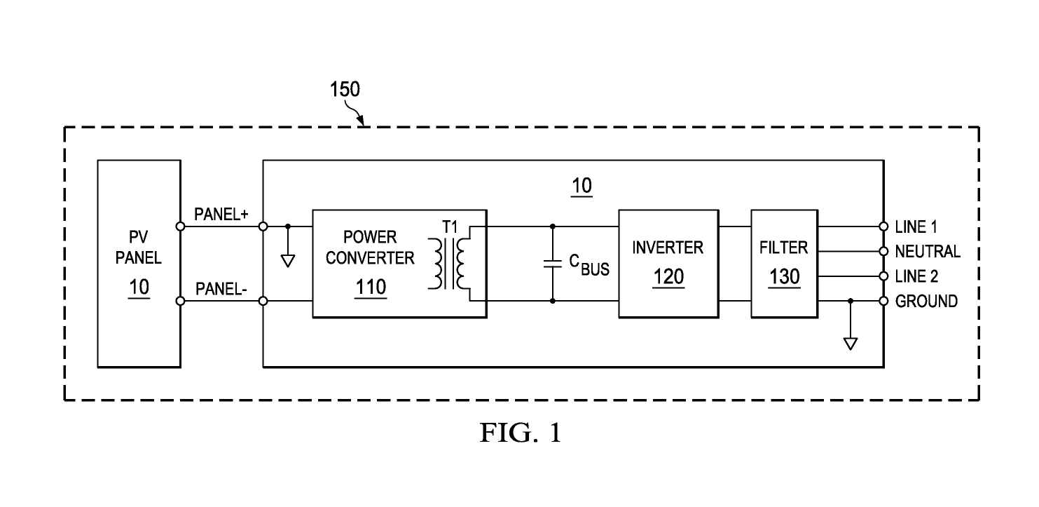

Turning now to FIG. 1, illustrated is a block diagram of an embodiment of a power supply 100 employable with a photovoltaic (“PV”) panel 10. The power supply 100 can convert an output characteristic (e.g., a dc output voltage) produced on terminals PANEL+, PANEL− of the PV panel 10 to an ac output voltage on terminals LINE 1, LINE 2. The power supply 100 can include a power converter (e.g., an isolated dc-dc boost power converter) 110 with a dc output voltage coupled across a bus capacitor C_{BUS}. As shown, the bus capacitor C_{BUS} is coupled to the input of an inverter 120, an ac output voltage of which is filtered by a filter 130 to remove high-frequency voltage components. An output of the filter 130 provides the ac output voltage on terminals LINE 1, LINE 2 with a NEUTRAL and safety GROUND connection.

Other circuit elements of the power supply 100 not illustrated in FIG. 1 may include one or more housekeeping bias voltage supplies, an input control integrated circuit (“IC”) for the power converter 110, an output control integrated circuit for the inverter 120, and an output power-line phase control function for the inverter 120. An isolating feedback control element, such as an opto-coupler, may be included to provide regulation of an internal circuit operating characteristic such as the voltage of an internal five volt bias voltage while spanning the isolation barrier provided by a transformer T1 of the power converter 110. As evident by the dashed enclosure indicating a PV module 150, the power supply 100 may be incorporated into or with the PV panel 10.

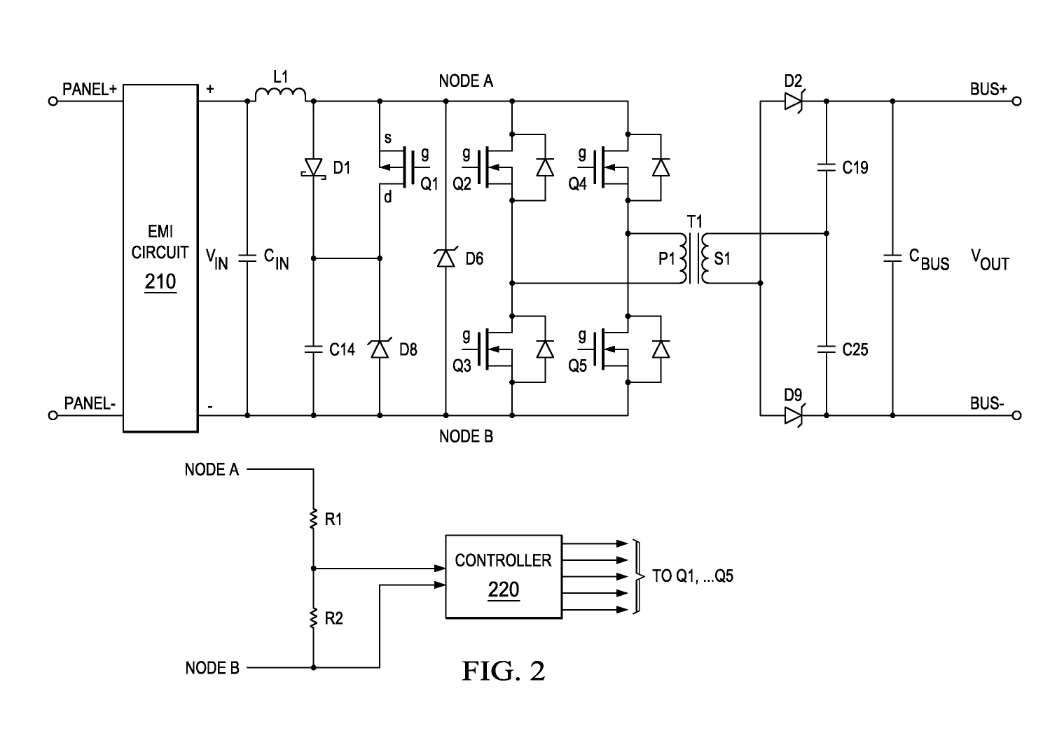

Turning now to FIG. 2, illustrated is a schematic diagram of an embodiment of a portion of a power supply employable with a PV panel. In particular, FIG. 2 illustrates a power converter (e.g., an isolated boost power converter, also known as a current-fed, full-bridge isolated boost power converter) employable within a power supply. The power converter can receive an output characteristic (e.g., a dc output voltage) produced on terminals PANEL+, PANEL− of the PV panel and provides a filtered input characteristic (e.g., input voltage) V_{IN} via an electromagnetic interference (“EMI”) suppression and protection circuit (also referred to as an “EMI circuit”) 210 and an input capacitor C_{IN}. The EMI circuit 210 can include circuit filter elements for differential and common-mode suppression of EMI currents that may be conducted between the PV panel and the power converter.

A full-bridge power train of the power converter can include first, second, third and fourth power switches (e.g., metal-oxide semiconductor field-effect transistors (“MOSFETs”) Q2, Q3, Q4, Q5. Other switching circuit power train topologies, such as a half bridge power train, are also within the scope of the present disclosure. The power converter can also include an input inductor (e.g., a boost input inductor) L1 coupled to the input capacitor C_{IN} and the full-bridge power train. A transformer T1 of the power converter can provide isolation between a primary side and secondary side thereof, and primary and secondary windings P1, S1 of the transformer T1 cooperate to provide a voltage gain within and as a function of an operation of the power converter.

A plurality of diodes (e.g., diodes D2, D9) can provide rectification of ac current produced on the secondary winding S1 of the transformer T1. A plurality of capacitors (e.g., capacitors C19, C25) can form a portion of a voltage-doubler rectification circuit on the secondary side of the transformer T1. An output characteristic (e.g., output voltage) V_{OUT} of the power converter appears across a bus capacitor (e.g., an output filter capacitor) C_{BUS}. A controller 220 can sense a voltage between a node A and a node B (via resistor divider formed with sense resistors R1, R2) and can provide control and gate-drive signals for the first, second, third and fourth power switches Q2, Q3, Q4, Q5 to regulate the output voltage V_{OUT} of the power converter. Further circuit elements such as housekeeping/bias power supplies and other control functions may also be included. These additional circuit components can be included to support the power converter and can be constructed in numerous circuit configurations to achieve particular design goals.

An active clamp circuit (also referred to as “an energy recovery circuit”) can include a clamp switch Q1, a clamp capacitor C14, and first, second and third clamp diodes D1, D6, D8. As shown in the example of FIG. 2, the first clamp diode D1 and the clamp capacitor C14 are coupled in series across the input capacitor C_{IN} of the power converter. The first clamp diode D1 is an optional diode recognizing that a body diode of the clamp switch Q1 may have inadequate recovery performance in some applications (i.e., switching speed). The second and third clamp diodes D6, D8 can provide overvoltage protection for the power converter. Generally, the first, second and third clamp diodes D1, D6, D8 can be Zener diodes or transient voltage suppressors (“TVSs”) that do not affect the normal operation of the active clamp circuit.

The active clamp circuit can recapture energy stored in the leakage inductance of transformer T1. The full-bridge power train can be switched so that the second and third power switches Q3, Q4 are substantially simultaneously turned on and off with a duty cycle slightly less than about 50 percent (such as about 45 to 49 percent). Also, the first and fourth power switches Q2, Q5 are simultaneously turned on and off with a duty cycle slightly less than 50 percent and 180 degrees out-of-phase with respect to the second and third power switches Q3, Q4. When, for example, the first and fourth power switches Q2, Q5 are turned on (and the second and third power switches Q3, Q4 are turned off), an inductor current flowing in the input inductor L1 is passed into the primary winding P1 of the transformer T1. The primary winding P1 initially carries little or no current, so the sudden addition of the inductor current from the input inductor L1 represents an abrupt change in the current level. The leakage inductance of the primary winding P1 of the transformer T1 experiences a rapid change in current. When the current changes rapidly, it produces a high voltage (i.e., a voltage spike), which can destroy the full-bridge power train or, at least cause the power train to operate inefficiently due to avalanche effects.

The first clamp diode D1 (and the body diode of the clamp switch Q1) provides a path for a difference between the inductor current through the input inductor L1 and a primary current flowing through the primary winding P1 of the transformer T1. The active clamp circuit, therefore, accommodates a temporary mismatch in current that occurs due to the switching action of the full-bridge power train. When such a switching event occurs, the first clamp diode D1 (and the body diode of the clamp switch Q1) conduct the mismatched current to the clamp capacitor C14 thereby charging the same. A succession of the switching events can cause the voltage sustained by the clamp capacitor C14 to charge to an excessive level.

To mitigate the above-referenced circumstance, the clamp switch Q1 provides a path to discharge the clamp capacitor C14. After a charging event, the clamp switch Q1 can be turned on momentarily by the controller 220 to return energy to the transformer T1. Since this switching event occurs frequently (such as at a frequency of 100 kilohertz (“kHz”)), the exchange of energy with the clamp capacitor C14 is periodic and frequent. Switching per se can be a relatively efficient process, so the active clamp circuit operates as an energy recovery circuit, since the energy directed into the clamp capacitor C14 is “recovered” by switching the clamp switch Q1.

Operation of the active clamp circuit illustrated in FIG. 2 can be very effective. The active clamp circuit, however, can generate significant levels of EMI. It does, however, relax the specification of the leakage inductance of the transformer T1. Ideally, the leakage inductance would be zero, but practically it has some non-zero value. The smaller the leakage inductance, the more expensive the transformer T1. Smaller leakage inductance can also lead to higher parasitic capacitance in the transformer T1, which can produce other detrimental effects.

An alternative to the active clamp circuit such as the circuit illustrated in FIG. 2 is a passive clamp circuit. The passive clamp circuit couples a dissipating resistor across the clamp capacitor C14 and eliminates the clamp switch Q1. This dissipating resistor can be in place of or in addition to the sense resistors R1, R2. This dissipating resistor, however, will have a relatively small resistance value to sufficiently “burn off” the excess energy that flows into the clamp capacitor C14. Otherwise, the clamp capacitor C14 would be charged to an unmanageably high voltage. Such a dissipative circuit can be detrimental to efficiency if the leakage inductance of the transformer T1 is high. Furthermore, the voltage of the clamp capacitor C14 is not directly controllable, so the performance of the passive clamp circuit can produce undesirable effects. For instance, the voltage of the clamp capacitor C14 may become too high as to alter the blocking voltage ratings of the first, second, third and fourth power switches Q2, Q3, Q4, Q5. Ideally, the voltage of the clamp capacitor C14 is sufficiently high to force a rapid current transition in the primary winding P1 of the transformer T1. With this passive clamp circuit, however, the voltage across the clamp capacitor C14 will vary uncontrollably with variations in the input voltage V_{IN}, frequency, output voltage V_{OUT}, and power output, resulting in unmanaged adverse effects.

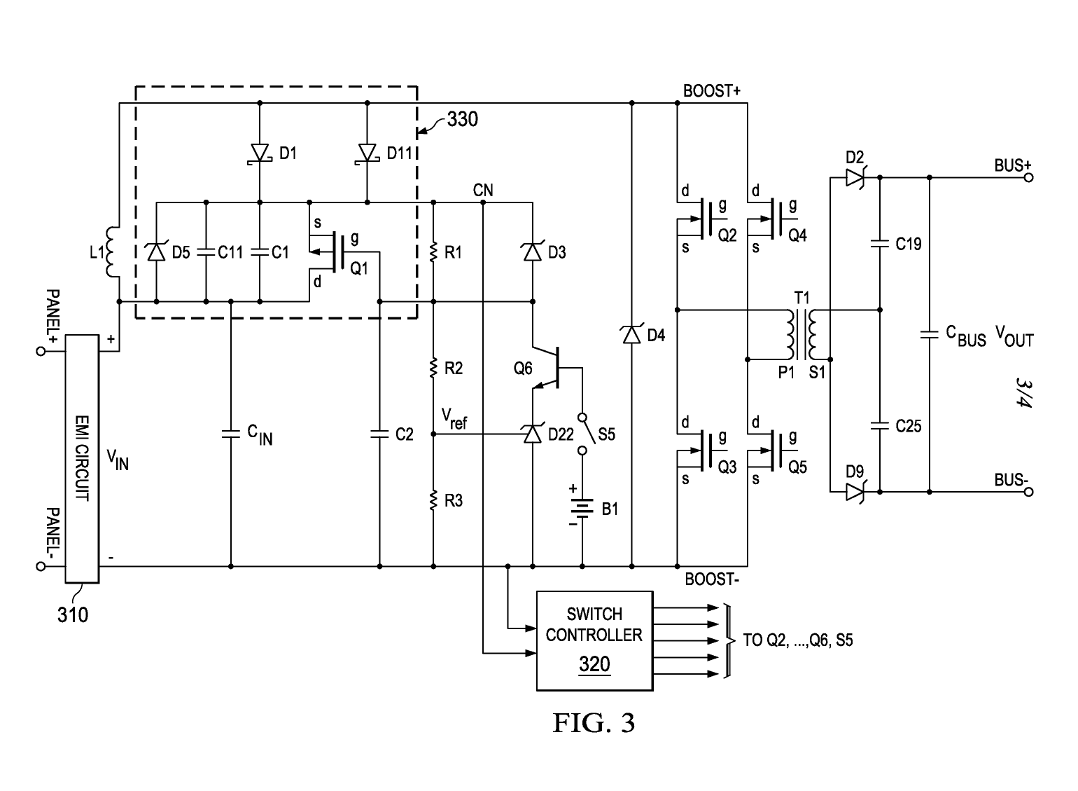

Turning now to FIG. 3, illustrated is a schematic diagram of another embodiment of a portion of a power supply employable with a PV panel. In particular, FIG. 3 illustrates a power converter (e.g., an isolated boost power converter, also known as a current-fed, full-bridge isolated boost power converter) employable within a power supply. The PV panel represents an input power source to the power converter and power supply. The power converter receives an output characteristic (e.g., a dc output voltage) produced on terminals PANEL+, PANEL− of the PV panel and provides a filtered input characteristic (e.g., input voltage) V_{IN} via an electromagnetic interference (“EMI”) suppression and protection circuit (also referred to as an “EMI circuit”) 310 and an input capacitor C_{IN}. The EMI circuit 310 includes circuit filter elements for differential and common-mode suppression of EMI currents that may be conducted between the PV panel and the power converter.

A full-bridge power train of the power converter is formed with first, second, third and fourth power switches (e.g., metal-oxide semiconductor field-effect transistors (“MOSFETs”) Q2, Q3, Q4, Q5. Of course other switching circuit power train topologies such as a half bridge power train are well within the broad scope of the present disclosure. The power converter also includes an input inductor (e.g., a boost input inductor) L1 coupled to the input capacitor C_{IN} and the full-bridge power train. A transformer T1 of the power converter provides isolation between a primary side and secondary side thereof, and primary and secondary windings P1, S1 of the transformer T1 cooperate to provide a voltage gain within and as a function of an operation of the power converter.

A plurality of diodes (e.g., diodes D2, D9) provide rectification of ac current produced on the secondary winding S1 of the transformer T1. A plurality of capacitors (e.g., capacitors C19, C25) form a portion of a voltage-doubler rectification circuit on the secondary side of the transformer T1. An output characteristic (e.g., an output voltage) V_{OUT} of the power converter appears across a bus capacitor (e.g., an output filter capacitor) C_{BUS}. A controller of the power converter includes a switch controller 320 that senses a voltage across a resistor divider network (e.g., formed with first, second and third sense resistors R1, R2, R3) and provides control signals for the first, second, third and fourth power switches Q2, Q3, Q4, Q5 to regulate the output voltage V_{OUT} of the power converter. Further circuit elements such as housekeeping/bias power supplies and other control functions may also be included. These additional circuit components can be included to support the power converter and can be constructed in numerous circuit configurations to achieve particular design goals.

The full-bridge power train is switched in a current-source power train topology controlled by the switch controller 320. Initially during a switching cycle, the first, second, third and fourth power switches Q2, Q3, Q4, Q5 are turned on and then a diagonal pair thereof are turned on and off. For instance, a diagonal pair of the second and third power switches Q3, Q4 are then turned on (and the first and fourth power switches Q2, Q5 are turned off) followed by a diagonal pair of the first and fourth power switches Q2, Q5 being turned on (and the second and third power switches Q3, Q4 are turned off).

When the first and fourth power switches Q2, Q5 are turned on (and the second and third power switches Q3, Q4 are turned off), an inductor current flowing in the input inductor L1 is passed into the primary winding P1 of the transformer T1. A voltage is impressed across the primary winding P1, which is coupled to the secondary winding S1, rectified by the plurality of diodes D2, D9 and ultimately appears as the output voltage V_{OUT} across the bus capacitor C_{BUS}. When the second and third power switches Q3, Q4 are turned on (and the first and fourth power switches Q2, Q5 are turned off), an inductor current flowing in the input inductor L1 is passed into the primary winding P1 of the transformer T1. A voltage of the opposite polarity is then impressed across the primary winding P1, which is coupled to the secondary winding S1, and is correspondingly rectified by the plurality of diodes D2, D9 and appears as the output voltage V_{OUT} across the bus capacitor C_{BUS}.

The duty cycle of each of the first, second, third and fourth power switches Q2, Q3, Q4, Q5 is greater than 50 percent. A general reference for current-source power train topologies is disclosed in “Switching Power Supply Design,” by Abraham Pressman, Keith Billings and Taylor Morey, The McGraw Hill Company (1991), which is herein incorporated by reference.

The power converter also includes a snubber circuit 330 coupled to the full-bridge power train. The snubber circuit 330 includes a series-coupled first clamp diode D1 and a first clamp capacitor C1 coupled across (e.g., directly across) the input inductor L1, but not across the input capacitor C_{IN}. An optional second clamp capacitor C11 is in a parallel circuit arrangement with and supplements the capacitance of the first clamp capacitor C1. The snubber circuit 330 also includes a clamp switch Q1 coupled across and configured to regulate a voltage of the first and second clamp capacitors C1, C11. The first and second clamp capacitors C1, C11 may be formed with the same and/or different capacitor technologies such as a ceramic capacitor and a tantalum capacitor to provide a combination of high-frequency by-pass performance with efficient capacitance physical size. An optional second clamp diode D11 is in a parallel circuit arrangement with and supplements the first clamp diode D1 and a body diode of the clamp switch Q1.

Note that a lower terminal of the first and second clamp capacitors C1, C11 is coupled to a positive terminal PANEL+ of the PV panel to reduce power dissipation in the controlled resistance of the clamp switch Q1. Accordingly, the clamp switch Q1 only dissipates capacitor charge associated with a portion of the voltage produced across positive and negative rails BOOST+, BOOST− associated with the full-bridge power train, which provides a substantial boost in efficiency associated therewith.

The clamp switch (e.g., p-channel MOSFET) Q1 shown with source “s”, gate “g”, and drain “d” terminals may be operated in a “linear” region as a controlled/adjustable resistance by a control voltage applied to the gate “g” terminal. As such, the clamp switch Q1 can be thought of as an adjustable variable linear resistor controlled by a feedback path created by the resistor divider network formed with the first, second and third sense resistors R1, R2, R3. As a result of the switching action of the full-bridge power train formed with the first, second, third and fourth power switches Q2, Q3, Q4, Q5, the first and second clamp capacitors C1, C11 capture energy resulting from a temporary mismatch between an inductor current through the input inductor L1 and a current through the leakage inductance of the primary winding P1 of the transformer P6. The clamp switch Q1 provides a path for and discharges energy stored in the first and second clamp capacitors C1, C11 as controlled by the feedback path. The clamp switch Q1 provides an efficient mechanism to regulate the voltage across the first and second clamp capacitors C1, C11 due, in part, because the voltage across to the first and second clamp capacitors C1, C11 is substantially smaller than the input voltage V_{IN} across the input capacitor C_{IN}.

The resistor divider network is also coupled to a reference input node V_{ref} of a diode/shunt regulator D22. The reference input node V_{ref} is coupled between the second and third sense resistors R2, R3 of the resistor divider network. The diode/shunt regulator D22 enables a backup circuit path to discharge the first and second clamp capacitors C1, C11 in series with the input capacitor C_{IN}. The dc voltage (i.e., the input voltage V_{IN}) produced across the input capacitor C_{IN} is a result of solar energy captured by the PV panel. The diode/shut regulator D22 is operative to control unnecessarily high dc voltage produced across the first and second clamp capacitors C1, C11 and the input capacitor C_{IN}, and sensed by the resistor divider network. A feedback path created by the resistor divider network and coupled to the reference input node V_{ref} of diode/shunt regulator D22 manages unnecessarily high dc voltages (e.g., above a threshold such as the blocking voltage of the bridge switches 90 volts) at a circuit node CN between the first and second clamp diodes D1, D11 and the first and second clamp capacitors C1, C11. More generally, the feedback path manages a high dc voltage at the circuit node CN so that it does not exceed the blocking voltage of the first, second, third or fourth power switches Q2, Q3, Q4, Q5, or some percentage thereof such as 90 percent, so as to maintain a margin of safety for the full-bridge power train. It is noted that the diode/shunt regulator D22 may be formed with a TL431 introduced below and does not substantially conduct when a voltage at the reference input node V_{ref} is less than about 2.5 volts, which represents an internal reference voltage of the diode/shunt regulator D22.

A filter capacitor C2 is a filter element coupled to the gate “g” of the clamp switch Q1 to ensure that noise does not adversely affect the operation of the clamp switch Q1. The resistor divider network is also employed to distribute a total voltage of the first and second clamp capacitors C1, C11 coupled in series with the positive and negative terminals PANEL+, PANEL− of the PV panel to various downstream circuit elements coupled to the positive and negative rails BOOST+, BOOST−.

The diode/shunt regulator D22 represents an active shunt regulator such as adjustable (precision) shunt regulator TL431 available from Texas Instruments and described in a datasheet entitled “TL43xx Precision Programmable Reference,” dated January 2015, which is incorporated herein by reference. The diode/shunt regulator D22 senses a voltage (via the reference input node V_{ref}) produced across terminals of the third sense resistor R3 and adjusts its current to regulate the voltage across the resistor divider network. A diode D3 is a Zener diode that is included for overvoltage protection and to provide a path for the shunt regulator current.

A control switch (e.g., a bipolar transistor) Q6 selectively enables and disables the diode/shunt regulator D22. By turning on the base current of the control switch Q6, the diode/shunt regulator D22 is effectively enabled. The control switch Q6 is also operative to protect the diode/shunt regulator D22 from a high voltage such as 90 volts versus a lower component voltage rating such as 30 volts. The base of the control switch Q6 is coupled to a low-voltage rail such as a +9 volt rail (represented schematically in FIG. 3 by a battery B1, i.e., a relatively steady source of dc voltage such as a bias voltage source) to prevent the diode/shunt regulator D22 from being exposed to a voltage greater than 9 volts. The current shunted by the diode/shunt regulator D22 passes through the control switch Q6 from the high voltage regulated positive rail BOOST+ with roughly a 1:1 current gain.

When a switch S5 is closed, voltage at the positive terminal of the battery B1 is coupled to the base of the control switch Q6. This enables the control switch Q6 to operate as an emitter follower to limit a voltage (e.g., a maximum voltage) applied to a cathode of the diode/shunt regulator D22. When the switch S5 is open (controllable by the switch controller 320), the switch controller 320 can reduce the voltage of the base of the control switch Q6 to disable operation of diode/shunt regulator D22.

When the control switch Q6 is enabled to conduct, the diode/shunt regulator D22 modifies a source-to-gate voltage of the clamp switch Q1. This voltage modification causes resistance of the clamp switch Q1 to change and to draw more or less current from the first and second clamp capacitors C1, C11, ultimately changing the voltage thereacross. Thus, the diode/shunt regulator D22 cooperates with the clamp switch Qlto manage the voltage of the first and second clamp capacitors C1, C11 as part of a backup circuit path described above. By suitable adjustment of circuit parameters, the voltage at the top end (at the circuit node CN) of the first and second clamp capacitors C1, C11 can be regulated to a desired value, with limited dependence on voltage produced by the PV panel, power level, etc. It should also be noted that the backup circuit path including the diode/shunt regulator D22 is only employed when the voltage at the circuit node CN crosses an unnecessarily high dc voltage such as a threshold as set forth above.

First and second Zener diodes D4, D5 are configured, respectively, to limit a voltage sustained between the positive and negative rails BOOST+, BOOST− and a voltage of the first and second clamp capacitors C1, C11. When the voltage between the positive and negative rails BOOST+, BOOST− exceeds an avalanche voltage of the first Zener diode D4, the first Zener diode D4 conducts to limit a voltage (e.g., a maximum voltage) sustained between the positive and negative rails BOOST+, BOOST−. When the voltage of the first and second clamp capacitors C1, C11 exceeds the avalanche voltage of the second Zener diode D5, the second Zener diode D5 conducts to limit a voltage (e.g., a maximum voltage) sustained by the first and second clamp capacitors C1, C11.

While the snubber circuit 330 is dissipative, the variable value of resistance of the clamp switch Q1 coupled to the positive terminal PANEL+ of the PV panel substantially reduces power dissipation for an operating power level of the PV panel, promoting higher efficiency over an operating range of the PV panel. If the clamp switch Q1 were a fixed resistor and coupled to the negative terminal PANEL− of the PV panel as in other passive clamp circuits, compromises would occur in efficiency and device selection. The snubber circuit 330 introduced herein provides a consistent clamping voltage that can be used to design the remaining components of the power converter. Importantly, transformer leakage inductance can be selected to balance efficiency, EMI, and transformer design trade-offs, rather than just being reduced (e.g., minimized) to improve power conversion efficiency.

As a passive circuit, the clamp switch Q1 can be controlled locally using the feedback path (coupled to a control terminal or gate “g” of the clamp switch Q1 and the circuit node CN coupled to a terminal of the first and second clamp capacitors C1, C11) with the resister divider network and without employing the switch controller 320. Local control of the clamp switch Q1 (as provided by the resistor divider network with high-voltage protection from the diode/shunt regulator D22) simplifies control circuit design and makes the circuit less sensitive to the value of transformer leakage inductance, which can vary substantially with manufacturing tolerances.

In a practical design, clamping components should be placed close to the primary winding P1 of the transformer T1 to improve performance and to reduce (e.g., minimize) EMI. The transformer leakage inductance can be selected to augment EMI performance and power conversion efficiency. Low values of leakage inductance can increase ringing effects and impact conducted interference, but can be managed with conventional circuit design techniques to contain transformer ringing in a particular design. An advantage of the snubber circuit described herein is that it is simpler and lower cost that alternatives such as the active clamp circuit. It does not require a gate drive circuit or the associated timing circuitry to control the gate drive circuit.

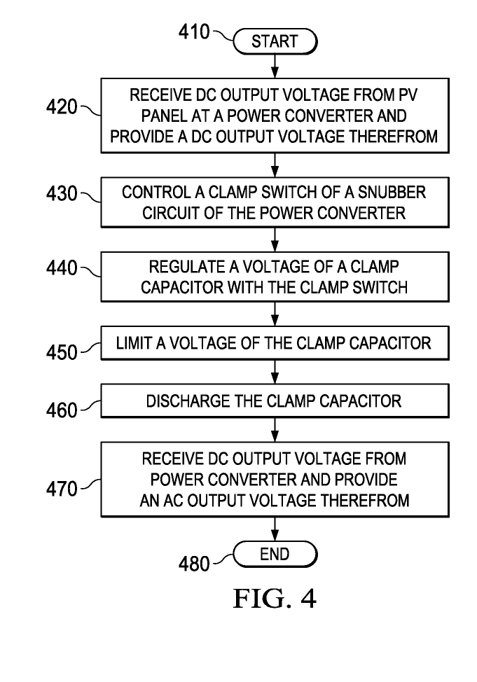

Turning now to FIG. 4, illustrated is a flow diagram of an embodiment of a method of operating a photovoltaic module. The method begins at a start step or module 410. At a step or module 420, a power converter receives a dc output voltage from a photovoltaic (“PV”) panel and provides a dc output voltage. The power converter may include an input inductor coupled to a winding of a transformer. The method also includes controlling a clamp switch of a snubber circuit (of the power converter) with a feedback path including a resistor divider network at a step or module 430. The clamp switch can be controlled to regulate a voltage of a clamp capacitor series-coupled to a clamp diode at a step or module 440. The series-coupled clamp capacitor and clamp diode may be coupled across the input inductor. The method may also include limiting the voltage of the clamp capacitor with, for instance, a Zener diode at a step or module 450. In accordance with the foregoing, the method includes discharging the clamp capacitor with, for instance, a shunt regulator coupled to the resistor divider network at a step or module 460. At a step or module 470, the method continues by receiving the dc output voltage from the power converter and providing an ac output voltage therefrom with, for instance, an inverter. The method concludes at an end step or module 480.

Those skilled in the art should understand that the previously described embodiments of a controller for a power converter and related methods of operating the same are submitted for illustrative purposes only. In addition, other embodiments capable of mitigating the effects of transformer leakage inductance employable with other power conversion arrangements are well within the broad scope of the present disclosure. While the snubber circuit has been described in the environment of a power converter, the snubber circuit may also be applied to other power systems such as, without limitation, a power amplifier or a motor controller.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A snubber circuit for use with a power converter having an input inductor coupled to a winding of a transformer, comprising:
a series-coupled clamp diode and clamp capacitor coupled across said input inductor; and
a clamp switch coupled across and configured to regulate a voltage of said clamp capacitor.

2. The snubber circuit as recited in claim 1 wherein said clamp capacitor comprises a parallel circuit arrangement of a plurality of capacitors.

3. The snubber circuit as recited in claim 1 wherein said clamp diode comprises a parallel circuit arrangement of a plurality of diodes.

4. The snubber circuit as recited in claim 1 wherein a feedback path is coupled to a terminal of said clamp capacitor and a control terminal of said clamp switch.

5. The snubber circuit as recited in claim 4 wherein said feedback path comprises a resistor divider network.

6. The snubber circuit as recited in claim 5 wherein a shunt regulator is coupled to said resistor divider network.

7. The snubber circuit as recited in claim 6 wherein a control switch is configured to disable an operation of said shunt regulator.

8. The snubber circuit as recited in claim 1 wherein a Zener diode is configured to limit said voltage of said clamp capacitor.

9. The snubber circuit as recited in claim 1 wherein an input filter capacitor is coupled between said clamp switch and an input power source to said power converter.

10. The snubber circuit as recited in claim 9 wherein said input power source comprises a photovoltaic panel.

11. The snubber circuit as recited in claim 1 wherein said clamp switch is operable as a variable linear resistor.

12. A photovoltaic module, comprising:
a power converter configured to receive a direct current (dc) output voltage from a photovoltaic panel and provide a dc output voltage, said power converter having an input inductor coupled to a winding of a transformer and snubber circuit, comprising:
a series-coupled clamp diode and clamp capacitor coupled across said input inductor; and
a clamp switch coupled across and configured to regulate a voltage of said clamp capacitor; and
an inverter configured to receive said dc output voltage from said power converter and provide an alternating current (ac) output voltage.

13. The photovoltaic module as recited in claim 12 further comprising a feedback path coupled to a terminal of said clamp capacitor and a control terminal of said clamp switch.

14. The photovoltaic module as recited in claim 13 wherein said feedback path comprises a resistor divider network.

15. The photovoltaic module as recited in claim 14 further comprising a shunt regulator coupled to said resistor divider network and a control switch configured to disable an operation thereof.

16. The photovoltaic module as recited in claim 13 further comprising a Zener diode configured to limit said voltage of said clamp capacitor.

17. A method of operating a photovoltaic module, comprising:
receiving a direct current (dc) output voltage at a power converter from a photovoltaic panel and providing a dc output voltage, said power converter having an input inductor coupled to a winding of a transformer;
regulating a voltage of a clamp capacitor series-coupled to a clamp diode with a clamp switch of a snubber circuit, said series-coupled clamp capacitor and clamp diode being coupled across said input inductor; and
receiving said dc output voltage from said power converter and providing an alternating current (ac) output voltage.

18. The method as recited in claim 17 further comprising controlling said clamp switch with a feedback path including a resistor divider network.

19. The method as recited in claim 18 further comprising discharging said clamp capacitor.

20. The method as recited in claim 17 further comprising limiting said voltage of said clamp capacitor with a Zener diode.
